(19) United States
(12) Patent Application Publication
(10) Pub. No.: US 2024/0383239 A1
(43) Pub. Date: Nov. 21, 2024

(54) HEAT-SHRINKABLE FILM

(71) Applicant: GUNZE LIMITED, Kyoto (JP)

(72) Inventors: Nobuhiro WATANABE, Shiga (JP); Jun TAKAICHI, Shiga (JP); Kensuke KAMEI, Shiga (JP)

(73) Assignee: GUNZE LIMITED, Kyoto (JP)

(21) Appl. No.: 18/293,922

(22) PCT Filed: Jul. 26, 2022
(86) PCT No.: PCT/JP2022/028722

§ 371 Date: Jan. 31, 2024

(30) Foreign Application Priority Data
Aug. 4, 2021 (JP) 2021-128540

(51) Int. Cl. B32B 27/08; B32B 27/30; B32B 27/32; B32B 27/36

(52) U.S. Cl. CPC B32B 27/08; B32B 27/302; B32B 27/32; B32B 27/36; B32B 2250/02; B32B 2250/24; B32B 2255/10; B32B 2255/26; B32B 2270/00; B32B 2307/4023; B32B 2307/414; B32B 2307/736; B32B 2307/75; B32B 2519/00

(57) ABSTRACT

A heat-shrinkable film for lamination of an ink layer formed by biomass ink includes a printing layer. The printing layer includes a thermoplastic resin and has a printing surface configured to allow the ink layer to be laminated. An oxidation induction time T (min) of the printing layer satisfies 0.15≤T≤12. The oxidation induction time T is an oxidation induction time T1 measurable in air at 200° C., an oxidation induction time T2 measurable in air at 230° C., or the shorter one of T1 and T2.

### TECHNICAL FIELD

The present disclosure relates to a heat-shrinkable film.

### BACKGROUND ART

Biomass resources, which are resources derived from living organisms, excluding fossil resources, draw attention as resources contributing to the construction of a recycling-oriented society. In recent years, progress has been made in the development of products in which the fossil resources in raw materials are partially or completely replaced with the biomass resources. Examples of such products include biomass ink for printing that uses plant-derived resources as the biomass resources.

Patent literature 1 discloses biomass ink having a biomass content of 10% or more. The term “biomass content” represents a mass ratio of components derived from the biomass resources in the solid ink component, and it is known as an index indicating a degree of utilization of the biomass resources. The biomass ink of Patent literature 1 includes a bio-polyurethane resin with a biomass content of 35% or more. According to Patent literature 1, using this bio-polyurethane resin as a binder for printing ink makes it possible to provide the biomass ink that has a biomass content of 10% or more and exhibits excellent adhesion performance to a plastic base material.

### CITATION LIST

### Patent Literature

Patent Literature 1: Japanese Patent No. 6637205

### SUMMARY OF INVENTION

### Technical Problem

Active use of biomass ink is preferable from the viewpoint of promoting a recycling-oriented society. In fact, efforts are being made to use the biomass ink for printing on a heat-shrinkable film. On the other hand, even when the biomass ink is used, it is necessary to meet the standard required as a product without reducing the printing quality. In particular, the higher the biomass content of the ink, the more difficult it becomes to maintain the printing quality. As such, there is also a need for the heat-shrinkable film to be more suitable for printing using the biomass ink.

An object of the present disclosure is to provide a heat-shrinkable film suitable for printing using biomass ink.

### Solution to Problem

Item (1): A heat-shrinkable film according to one aspect of the present disclosure is a heat-shrinkable film for lamination of an ink layer formed of biomass ink. The heat-shrinkable film includes a printing layer. The printing layer includes a thermoplastic resin and has a printing surface configured to allow the ink layer to be laminated. An oxidation induction time T (min) of the printing layer satisfies 0.15≤T≤12. The oxidation induction time T is an oxidation induction time T1 measurable in air at 200° C., an oxidation induction time T2 measurable in air at 230° C., or the shorter one of T1 and T2.
Item (2): In the heat-shrinkable film according to the above item (1), the printing layer may mainly include any of an olefin-based resin, an ester-based resin, and a styrene-based resin.
Item (3): The heat-shrinkable film according to the above item (1) or item (2) may further include a base material layer including a thermoplastic resin and laminated on a surface of the printing layer opposite to the printing surface.
Item (4): In the heat-shrinkable film according to any one of the above items (1) to (3), the oxidation induction time T (min) may satisfy 0.2≤T≤5.
Item (5): In the heat-shrinkable film according to any one of the above items (1) to (4), the biomass ink may include a urethane-based resin, and the urethane-based resin may include a component derived from a biomass resource.
Item (6): In the heat-shrinkable film according to any one of the above items (1) to (5), a biomass content of the biomass ink may be 10% or more.
Item (7): The heat-shrinkable film according to any one of the above items (1) to (6) may have the ink layer laminated on the printing surface.
Item (8): The heat-shrinkable film having the ink layer laminated on the printing surface, according to any one of the above items (1) to (7), may be included in a heat-shrinkable label.

### Advantageous Effects of Invention

According to the above, it is possible to provide the heat-shrinkable film that can maintain the printing quality even in printing using the biomass ink.

### BRIEF DESCRIPTION OF DRAWINGS

FIG. 1 is a diagram illustrating a cross-sectional configuration of a heat-shrinkable film according to one embodiment.

FIG. 2 is a diagram illustrating a cross-sectional configuration of the heat-shrinkable film according to one embodiment.

FIG. 3 is a diagram illustrating a cross-sectional configuration of the heat-shrinkable film according to one embodiment.

FIG. 4 is a DSC curve graph.

### DESCRIPTION OF EMBODIMENTS

Hereinafter, one embodiment of a heat-shrinkable film according to the present disclosure will be described. The heat-shrinkable film is a film composed of a thermoplastic resin and is suitable as a base film for a heat-shrinkable label attached to a container such as a plastic bottle or a resin-molded container. Note that the heat-shrinkable film “being composed of a thermoplastic resin” means that the main component of the heat-shrinkable film is a thermoplastic resin. That is, the heat-shrinkable film may include a component other than the thermoplastic resin, such as an additive, as necessary.

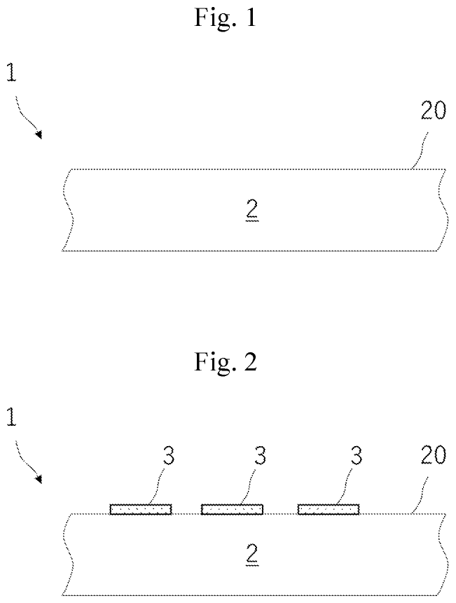

FIG. 1 shows a cross-sectional configuration of a heat-shrinkable film 1 according to one embodiment. As shown in FIG. 1, the heat-shrinkable film 1 includes a printing layer 2. The printing layer 2 is a layer composed of a thermoplastic resin, and at least one side thereof forms a printing surface 20. Note that the printing layer 2 “being composed of a thermoplastic resin” means that the main component of the printing layer 2 is a thermoplastic resin. The printing surface 20 is a surface on which an ink layer 3 is to be laminated. The ink layer 3 is a layer formed by printing using biomass ink, and the details thereof will be described below. FIG. 2 shows a cross-sectional configuration of the heat-shrinkable film 1 in which the ink layer 3 is laminated on the printing surface 20.

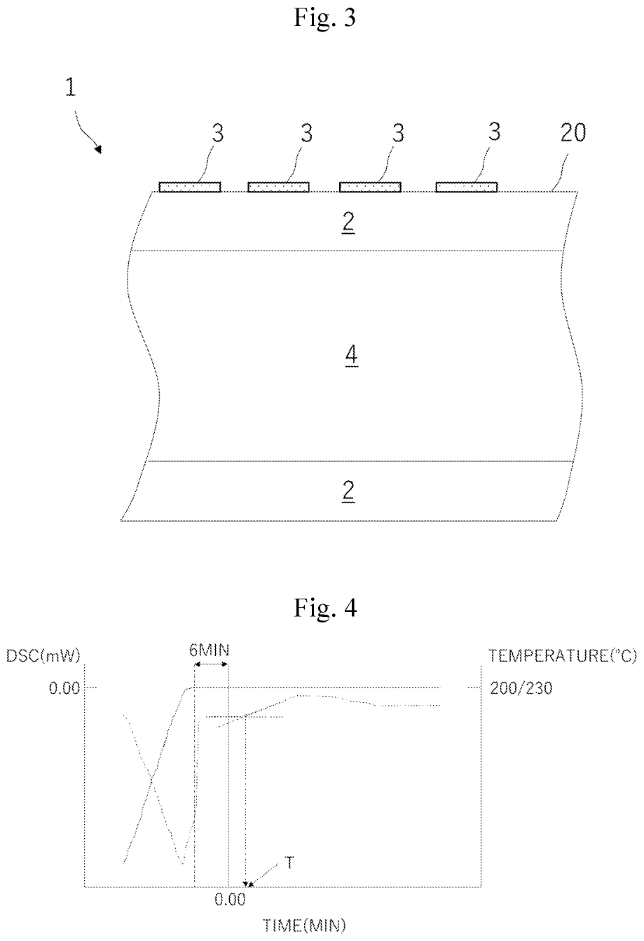

The heat-shrinkable film 1 may further include one or more layers composed of a thermoplastic resin in addition to the printing layer 2. For example, as shown in FIG. 3, the heat-shrinkable film 1 may include a base material layer 4 and the printing layers 2 laminated on both sides of the base material layer 4. In this case, both surfaces of the heat-shrinkable film 1 can be used as the printing surface 20. Each member will be described in detail below.

### 1. Printing Layer

Examples of the thermoplastic resin constituting the printing layer 2 according to the present embodiment include an olefin-based resin, an ester-based resin, and a styrene-based resin. Regardless of which thermoplastic resin is mainly included in the printing layer 2, the printing layer 2 exhibits characteristics suitable for forming the ink layer 3 on the printing surface 20 by adjusting an oxidation induction time T (min) of the thermoplastic resin within an appropriate range. Hereinafter, each thermoplastic resin will be described, and then the oxidation induction time T thereof will be described.

### [Olefin-Based Resin]

Examples of the olefin-based resin include a propylene-based resin, an ethylene-based resin, a cyclic olefin-based resin, a petroleum resin, and so on. In the present embodiment, a cyclic olefin-based resin, an ethylene-based resin, a petroleum resin, and a mixed resin thereof are preferable.

### [Cyclic Olefin-Based Resin]

The cyclic olefin-based resin can reduce crystallinity, increase a heat shrinkage rate, and improve stretchability during production of the heat-shrinkable film 1. Examples of the cyclic olefin-based resin include (a) a random copolymer of ethylene or propylene and a cyclic olefin, (b) a ring-opening polymer of the cyclic olefin or a copolymer of the cyclic olefin and an α-olefin, (c) a hydrogenated product of the above polymer (b), and (d) a graft-modified product of (a) to (c) with an unsaturated carboxylic acid, a derivative thereof, or the like.

The cyclic olefin is not particularly limited, and examples thereof include a norbornene and a derivative thereof, such as norbomene, 6-methylnorbornene, 6-ethylnorbornene, 5-propylnorbornene, 6-n-butylnorbornene, 1-methylnorbornene, 7-methylnorbornene, 5,6-dimethylnorbornene, 5-phenylnorbornene, and 5-benzylnorbornene. Examples of the cyclic olefin further include a tetracyclododecene and a derivative thereof, such as tetracyclododecene, 8-methyltetracyclo-3-dodecene, 8-ethyltetracyclo-3-dodecene, and 5,10-dimethyltetracyclo-3-dodecene.

The α-olefin is not particularly limited, and examples thereof include 1-butene, 1-pentene, 1-hexene, 4-methyl-1-pentene, and 1-octene.

The number average molecular weight of the cyclic olefin-based resin measured by a gel permeation chromatography (GPC) method is preferably 1,000 or more, and preferably 1,000,000 or less. Adjusting the number average molecular weight within the above-mentioned range facilitates film formation.

The glass transition temperature of the cyclic olefin-based resin is preferably 20° C. or higher, more preferably 50° C. or higher, and preferably 130° C. or lower, more preferably 100° C. or lower. In other words, the above-mentioned glass transition temperature is preferably 20° C. to 130° C., more preferably 50° C. to 100° C. When the above-mentioned glass transition temperature is 20° C. or higher, the heat resistance of the printing layer 2 is improved. Further, in the installation line for attaching a heat-shrinkable label including the heat-shrinkable film 1 to a container, it is possible to prevent the occurrence of blocking between these containers. Further, the natural shrinkage rate can be kept within a favorable range. When the above-mentioned glass transition temperature is 130° C. or lower, the heat shrinkage rate in the main shrinkage direction can be sufficiently increased. On the other hand, if the glass transition temperature exceeds 130° C., resin whitening may easily occur during stretching.

The above-mentioned glass transition temperature can be measured by a method according to ISO 3146. Note that, when the above-mentioned cyclic olefin-based resin is a mixed resin including multiple cyclic olefin-based resins with different glass transition temperature, the glass transition temperature of the above-mentioned mixed resin is defined by an apparent glass transition temperature calculated based on the mass ratio and glass transition temperature of the cyclic olefin-based resins in the mixed resin.

The density of the above-mentioned cyclic olefin-based resin is preferably 1,000 kg/m³ or more and 1,050 kg/m³ or less, more preferably 1,010 kg/m³ or more and 1,040 kg/m³ or less.

Examples of a commercially available product of the above-mentioned cyclic olefin-based resin include APEL (manufactured by Mitsui Chemicals, Inc.), TOPAS COC (manufactured by Polyplastics Co., Ltd.), and ZEONOR (manufactured by ZEON Corp.).

The printing layer 2 includes the above-mentioned cyclic olefin-based resin in an amount of preferably 20% by mass or more, more preferably 30% by mass or more, based on 100% by mass of the thermoplastic resin component constituting the printing layer 2.

### [Ethylene-Based Resin]

The ethylene-based resin improves the sebum whitening resistance of the heat-shrinkable film 1. When a fatty acid ester such as sebum adheres to the above-mentioned cyclic olefin-based resin, the adhered part may turn white after heat shrinkage. The sebum whitening can be prevented by mixing the above-mentioned cyclic olefin-based resin with the ethylene-based resin.

Examples of the ethylene-based resin include a branched low-density polyethylene, a linear low-density polyethylene, an ethylene-vinyl acetate copolymer, an ionomer resin, and a mixture thereof. Of these, a linear low-density polyethylene is preferable.

The linear low-density polyethylene is a copolymer of ethylene and α-olefin. Examples of α-olefin include the same α-olefin as in the above-mentioned example. The density of the linear low-density polyethylene is preferably 0.88 g/cm³ or more and 0.94 g/cm³ or less.

Examples of a commercially available product of the above-mentioned linear low-density polyethylene resin include Evolue (manufactured by Prime Polymer Co., Ltd.), UMERIT (manufactured by UBE-MARUZEN POLYETHYLENE Co., Ltd.), and NOVATEC (manufactured by Japan Polyethylene Corp.).

When the printing layer 2 includes the ethylene-based resin, it is preferable that the above-mentioned ethylene-based resin is included in an amount of 75% by mass or less based on 100% by mass of the thermoplastic resin component constituting the printing layer 2.

### [Petroleum Resin]

The petroleum resin is an aliphatic hydrocarbon resin, an aromatic hydrocarbon resin, an alicyclic hydrocarbon resin, obtained by polymerizing a C5 or C9 fraction produced by thermal decomposition of naphtha or a mixture thereof, or a hydrogenated product thereof. Of these, a hydrogenated alicyclic hydrocarbon resin having a partially or completely hydrogenated alicyclic structure is preferable from the viewpoint of preventing softening of the film at 100° C. or lower and ensuring transparency and rigidity.

The softening point of the petroleum resin is preferably 100° C. or higher and 150° C. or lower, more preferably 120° C. or higher and 130° C. or lower. When the softening point of the petroleum resin is within the above-mentioned range, the heat shrinkability can be kept within a favorable range.

Examples of a commercially available product of the above-mentioned petroleum resin include I-MARV (manufactured by Idemitsu Kosan Co., Ltd.), ARKON (manufactured by Arakawa Chemical Industries, Ltd.), and Regalite (manufactured by Eastman Chemical Company).

When the printing layer 2 includes the petroleum resin, it is preferable that the above-mentioned petroleum resin is included in an amount of 5% by mass to 40% by mass based on 100% by mass of the thermoplastic resin component constituting the printing layer 2.

### [Ester-Based Resin]

Examples of the ester-based resin include those obtained by condensation polymerization of a dicarboxylic acid component and a diol component. Examples of the dicarboxylic acid component include terephthalic acid, o-phthalic acid, isophthalic acid, succinic acid, adipic acid, sebacic acid, azelaic acid, octylsuccinic acid, cyclohexanedicarboxylic acid, naphthalenedicarboxylic acid, fumaric acid, maleic acid, itaconic acid, decamethylene carboxylic acid, and an anhydride and lower alkyl ester acid thereof. Of these, terephthalic acid is preferable.

Examples of the diol include an aliphatic diol such as ethylene glycol, 1,3-propanediol, 1,4-butanediol, diethylene glycol, 1,5-pentanediol, 1,6-hexanediol, dipropylene glycol, triethylene glycol, tetraethylene glycol, 1,2-propane diol, 1,3-butanediol, 2,3-butanediol, neopentyl glycol (2,2-dimethylpropane-1,3-diol), 1,2-hexanediol, 2,5-hexanediol, 2-methyl-2,4-pentanediol, 3-methyl-1,3-pentanediol, 2-ethyl-1,3-hexanediol, or poly (tetramethylene ether) glycol; and an alicyclic diol such as an alkylene oxide adduct of 2,2-bis (4-hydroxycyclohexyl) propane, 1,4-cyclohexanediol, or 1,4-cyclohexanedimethanol. Of these, ethylene glycol, diethylene glycol, and 1,4-cyclohexanedimethanol are preferable.

The glass transition temperature of the above-mentioned ester-based resin is preferably 55° C. or higher, more preferably 60° C. or higher, still more preferably 65° C. or higher. Further, the glass transition temperature of the above-mentioned ester resin is preferably 95° C. or lower, more preferably 90° C. or lower, still more preferably 85° C. or lower. In other words, the above-mentioned glass transition temperature is preferably 55° C. to 95° C., more preferably 60° C. to 90° C., still more preferably 65° C. to 85° C. If the above-mentioned glass transition temperature is lower than 55° C., the shrinkage start temperature of the heat-shrinkable film 1 may become too low, the natural shrinkage rate may increase, or blocking may easily occur. If the above-mentioned glass transition temperature exceeds 95° C., the low-temperature shrinkability and shrinkage finish of the heat-shrinkable film 1 may decrease, the decrease in the low-temperature shrinkability may become larger over time, or resin whitening may easily occur during stretching.

The above-mentioned glass transition temperature can be measured by a method according to ISO 3146. Note that, when the above-mentioned ester-based resin is a mixed resin including multiple ester-based resins with different glass transition temperature, the glass transition temperature of the above-mentioned mixed resin is defined by an apparent glass transition temperature calculated based on the mass ratio and glass transition temperature of the ester-based resins in the mixed resin.

### [Styrene-Based Resin]

Examples of the styrene-based resin include an aromatic vinyl hydrocarbon-conjugated diene copolymer, a mixed resin of an aromatic vinyl hydrocarbon-conjugated diene copolymer and an aromatic vinyl hydrocarbon-aliphatic unsaturated carboxylic acid ester copolymer, a rubber-modified impact-resistant polystyrene, and so on. When the above-mentioned styrene-based resin is used, the shrinkability of the heat-shrinkable film 1 is improved.

The aromatic vinyl hydrocarbon-conjugated diene copolymer is a copolymer including a component derived from an aromatic vinyl hydrocarbon and a component derived from a conjugated diene. The aromatic vinyl hydrocarbon is not particularly limited, and examples thereof include styrene, o-methyl styrene, p-methyl styrene, and so on. These may be used alone or in combination of two or more. Further, the conjugated diene is not particularly limited, and examples thereof include 1,3-butadiene, 2,3-dimethyl-1,3-butadiene, 1,3-pentadiene, 1,3-hexadiene, and so on. These may be used alone or in combination of two or more.

The above-mentioned aromatic vinyl hydrocarbon-conjugated diene copolymer preferably includes a styrene-butadiene block copolymer (SBS resin) from the viewpoint of improving heat shrinkability. Further, the above-mentioned SBS resin may be a single SBS resin, or two or more types of SBS resins may be used in combination.

The above-mentioned styrene-based resin includes a styrene component in an amount of preferably 65% by mass or more, more preferably 70% by mass or more, and preferably 90% by mass or less, more preferably 85% by mass or less. In other words, the above-mentioned styrene-based resin includes a styrene component in an amount of preferably 65% by mass to 90% by mass, more preferably 70% by mass to 85% by mass. When the content of the above-mentioned styrene component is 65% by mass or more, an impurity such as gel is less likely to be generated during forming processing, and the mechanical strength of the heat-shrinkable film 1 is improved. When the content of the above-mentioned styrene component is 90% by mass or less, the heat-shrinkable film 1 is less likely to be ruptured when the tension is applied to the heat-shrinkable film 1 or during processing such as printing.

The Vicat softening temperature of the above-mentioned styrene-based resin is preferably 60° C. or higher, more preferably 65° C. or higher, and preferably 85° C. or lower, more preferably 75° C. or lower. In other words, the Vicat softening temperature of the above-mentioned styrene-based resin is preferably 60° C. to 85° C., more preferably 65° C. to 75° C. If the above-mentioned Vicat softening temperature is lower than 60° C., the low-temperature shrinkability of the heat-shrinkable film 1 becomes too high, and wrinkles easily occur when the heat-shrinkable film 1 is attached to a container as a label. If the above-mentioned Vicat softening temperature exceeds 85° C., the low-temperature shrinkability of the heat-shrinkable film 1 decreases, and insufficient shrinkage tends to occur in some parts when the heat-shrinkable film 1 is attached to a container as a label.

The above-mentioned Vicat softening temperature can be measured by a method according to ISO 306:1994. Note that, when the above-mentioned styrene-based resin is a mixed resin including two or more styrene-based resins with different Vicat softening temperature, the Vicat softening temperature of the above-mentioned mixed resin is defined by an apparent Vicat softening temperature calculated based on the mass ratio and the Vicat softening temperature of the styrene-based resins in the mixed resin.

The melt flow rate (MFR) of the above-mentioned styrene-based resin at 200° C. is preferably 2 g/10 min or more and 15 g/10 min or less. If the above-mentioned MFR is less than 2 g/10 min, it becomes difficult to form a film with the above-mentioned styrene resin. If the above-mentioned MFR exceeds 15 g/10 min, the mechanical strength of the printing layer 2 becomes low enough to cause practical problems.

The printing layer 2 may include a fine particle in addition to the thermoplastic resin. The fine particle can be added to improve, for example, anti-blocking performance of the heat-shrinkable film 1. As such a fine particle, both an organic fine particle and an inorganic fine particle can be used. As the organic fine particle, an organic fine particle such as an acrylic resin fine particle, a styrene-based resin fine particle, a styrene-acrylic resin fine particle, a urethane-based resin fine particle, or a silicone-based resin fine particle can be used. In particular, from the viewpoint of compatibility with the cyclic olefin-based resin, an acrylic resin fine particle is preferable, and a cross-linked poly (methyl methacrylate)-based fine particle is more preferable.

Examples of a commercially available product of the above-mentioned organic fine particle include TECHPOLYMER (manufactured by Sekisui Kasei Co., Ltd.), Fine Sphere (manufactured by Nipponpaint Industrial Coatings Co., Ltd.), GANZPEARL (manufactured by Aica Kogyo Co., Ltd.), and ART PEARL (manufactured by Negami Chemical Industrial Co., Ltd.).

As the inorganic fine particle, for example, silica, zeolite, alumina, or the like can be used.

The printing layer 2 includes the above-mentioned fine particle in an amount of preferably 0.01 parts by mass or more and 0.10 parts by mass or less, more preferably 0.03 part by mass or more and 0.08 part by mass or less, based on a total of 100 of the thermoplastic resin constituting the printing layer 2.

### [Oxidation Induction Time]

As a result of extensive studies, the present inventor has found that the heat-shrinkable film 1 suitable for printing using the biomass ink can be provided by adjusting an oxidation induction time T (min) of the printing layer 2 within an appropriate range. The oxidation induction time T is an index that evaluates the tendency for a substance to be oxidized at a given temperature. The shorter the time T, the faster the oxidation reaction proceeds, and the longer the time T, the slower the oxidation reaction proceeds.

The oxidation induction time T in the present embodiment is measured by the following method.
(1) Measure out 5 mg of the printing layer 2 after film formation and surface treatment but before printing and heat shrinkage to collect a sample.
(2) Set the sample in an aluminum cell of a differential scanning calorimeter (DSC-60 manufactured by Shimadzu Corp.), and raise the temperature of nitrogen gas inside the measurement device from room temperature to the setting temperature (200° C. or 230° C.). The temperature rising rate is 30° C./min.
(3) Allow the sample to stand for 6 minutes after the setting temperature in (2) is reached.
(4) Switch the nitrogen gas to air gas (ALPHAGAZ AIR, ALPHAGAZ 2 manufactured by Air Liquide Japan G.K.) at the setting temperature.
(5) With the gas switching time as the start point (0 minutes 0 seconds), the detection time by the device from the start point to the rising point of the exothermic peak of the differential scanning calorimetry (DSC) caused by oxidation reaction is taken as the oxidation induction time T in the air. FIG. 4 is an example of a DSC curve (dashed line) shown with an ambient temperature curve (solid line). The horizontal axis of the graph represents time, the left vertical axis represents the DSC (mW), and the right vertical axis represents the ambient temperature (° C.).

The oxidation induction time T may be either an oxidation induction time T1 measurable at the setting temperature condition of 200° C. or an oxidation induction time T2 measurable at the setting temperature condition of 230° C. in the above (2). This is because the oxidation induction time is not always measurable under both temperature conditions depending on the composition of the printing layer 2. When both oxidation induction times T1 and T2 are measurable, the shorter one of T1 and T2 is taken as the oxidation induction time T.

The oxidation induction time T is preferably 0.15 minutes or longer, more preferably 0.2 minutes or longer. If the oxidation induction time T is shorter than 0.15 minutes, minute protrusions are likely to occur on the printing surface 20. Particularly, these protrusions deteriorate the fixation of the biomass ink and tend to cause printing omissions. Further, the oxidation induction time T is preferably 12 minutes or shorter, more preferably 5 minutes or shorter. If the oxidation induction time T exceeds 12 minutes, the haze of the clear ink-applied part of the biomass ink increases after shrinkage, likely resulting in deterioration of transparency. Thus, the oxidation induction time Tis preferably 0.15 minutes to 12 minutes, more preferably 0.2 minutes to 5 minutes.

The oxidation induction time T can be controlled by adjusting the addition amount of an antioxidant or modifying the production step of the heat-shrinkable film 1. For example, the more the antioxidant is added to the thermoplastic resin constituting the printing layer 2, the longer the oxidation induction time T becomes, and the less the antioxidant is added, the shorter the oxidation induction time T becomes. Further, in an extrusion molding step of the heat-shrinkable film 1, the longer the residence time in the extruder, the shorter the oxidation induction time T tends to be, and the shorter the residence time, the longer the oxidation induction time T tends to be. Further, the longer the kneading time of the thermoplastic resin constituting the printing layer 2, in addition to or instead of this, the more the number of kneading times, the shorter the oxidation induction time T tends to be. The shorter the kneading time, in addition to or instead of this, the less the number of kneading times, the longer the oxidation induction time T tends to be. Further, the oxidation induction time T tends to become shorter as the number of melt-processing step times increases during the production of the heat-shrinkable film 1, and the oxidation induction time T tends to become longer as the number of melt-processing step times decreases. Note that the melt-processing step is preferably introduced particularly when shreds (“fluff”) obtained by crushing a resin film product or an intermediate product thereof is used as a recycled raw material, and the number of the processing step can be adjusted as appropriate depending on specifications of the heat-shrinkable film 1 and properties of the shreds.

### [Thickness]

When the heat-shrinkable film 1 includes the base material layer 4 and the printing layer 2, the thickness of the printing layer 2 is not particularly limited. However, the thickness is preferably 0.4 μm or more, more preferably 0.6 μm or more, and preferably 10 μm or less, more preferably 5 μm or less. In other words, the thickness of the printing layer 2 is preferably 0.4 μm to 10 μm, more preferably 0.6 μm to 5 μm.

### <2. Ink Layer>

The ink layer 3 is a layer formed by applying the biomass ink onto the printing surface 20. The biomass ink forming the ink layer 3 is a printing ink composition including a biomass resource-derived component. The biomass resource-derived component may be included in any of a pigment, a binder resin, and any other solvent. However, in the present embodiment, the biomass resource-derived component is particularly preferably included in the binder resin.

The above-mentioned binder resin preferably incudes a biomass urethane-based resin as the biomass resource-derived component. The urethane-based resin is a resin including a urethane bond in the molecular chain, and it is typically obtained by a reaction between an isocyanate and a polyol. The urethane-based resin may further include, in the molecular chain, a urea bond obtained by a reaction between an isocyanate and an amine in addition to the urethane bond.

As the above-mentioned biomass urethane-based resin, a known biomass urethane-based resin such as the one disclosed in Patent literature 1 or the like can be used. Of such biomass urethane-based resins, the one including a biomass polyol derived from a biomass resource as a polymerization component is preferable. Examples of the biomass polyol include a biomass resource-derived polyester polyol and a biomass resource-derived polyether polyol. Of these, a biomass resource-derived polyester polyol is preferable.

The biomass content of the above-mentioned biomass ink is not particularly limited. However, it is preferably 10% or more, more preferably 15% or more.

### <3. Base Material Layer>

When the heat-shrinkable film 1 includes the base material layer 4 composed of a thermoplastic resin, examples of the thermoplastic resin include, but are not limited to, an olefin-based resin and a styrene-based resin. Note that the base material layer 4 “composed of a thermoplastic resin” means that the main component of the base material layer 4 is the thermoplastic resin. A combination of the olefin-based resin and the styrene-based resin constituting the base material layer 4 and the olefin-based resin, the ester-based resin, and the styrene-based resin constituting the printing layer 2 is not particularly limited, and any combination is possible.

### [Olefin-Based Resin]

Examples of the olefin-based resin include a propylene-based resin. The propylene-based resin is preferably a random bipolymer or a random terpolymer including propylene as a main component and α-olefin as a copolymer component. Examples of α-olefin include ethylene, 1-butene, 1-hexene, and 1-octene, and two or more types of α-olefins may be included. More specifically, mention may be made of a random bipolymer of propylene and ethylene, and a random terpolymer of propylene, ethylene and butene.

The deflection temperature under load (0.45 MPa) of the propylene-based resin is preferably 110° C. or lower, more preferably 90° C. or lower. When this propylene-based resin is a mixed resin including two or more types of propylene-based resins with different deflection temperature under load, the deflection temperature under load of the above-mentioned propylene-based resin means an apparent deflection temperature under load calculated by summing the product of the deflection temperature under load and the blending ratio (weight ratio) of each propylene-based resin.

Examples of a commercially available product of the above-mentioned propylene-based resin include Adsyl (manufactured by LyondellBasell Industries) and NOVATEC (manufactured by Japan Polypropylene Corp.).

### [Styrene-Based Resin]

The styrene-based resin is the same as the styrene-based resin previously described for the printing layer 2. In the present embodiment, the base material layer 4 includes a styrene-butadiene block copolymer (SBS resin).

### [Thickness]

The thickness of the base material layer 4 is not particularly limited. However, it is preferably 15 μm or more, more preferably 20 μm or more, and preferably 50 μm or less, more preferably 30 μm or less. In other words, the thickness of the base material layer 4 is preferably 15 μm to 50 μm, more preferably 20 μm to 30 μm.

### <4. Other Configurations>

The printing layer 2 and the base material layer 4 may each include, as necessary, an additive such as an antioxidant, a heat stabilizer, an ultraviolet absorber, a light stabilizer, a lubricant, an antistatic agent, a flame retardant, an antibacterial agent, a fluorescent brightening agent, or a colorant. As mentioned above, the addition amount of the antioxidant can be adjusted to control the oxidation induction time of the printing layer 2. Further, the heat-shrinkable film 1 may further include an adhesive layer composed of an adhesive resin between the base material layer 4 and the printing layer 2.

Further, the heat-shrinkable film 1 can include the biomass resource-derived component in at least one of the printing layer 2 and the base material layer 4. In this case, the biomass content of the entire heat-shrinkable film 1 (excluding the ink layer 3) is preferably 10% or more. The biomass content of the heat-shrinkable film 1 is calculated by the mass ratio of the biomass resource-derived component relative to the mass of the entire heat-shrinkable film 1 excluding the ink layer 3. Note that whether or not a raw material includes the biomass resource-derived component can be confirmed by examining whether or not approximately 105.5 pMC of radioactive carbon (C14) is included in all carbon atoms included in the raw material. The presence of the radioactive carbon (C14) can be measured using an accelerator mass spectrometer according to ISO 16620-2:2015.

### [Thickness]

The overall thickness of the entire heat-shrinkable film 1 excluding the ink layer 3 is not particularly limited. However, it is preferably 20 μm or more and 80 μm or less. When the thickness of the heat-shrinkable film 1 is within the above-mentioned range, not only excellent heat-shrinkability is obtained, but also the attachability to the container is improved. Further, when the heat-shrinkable film 1 includes the base material layer 4 and the printing layer 2, the ratio of the thickness of the printing layer 2 (one layer) and the thickness of the base material layer 4 is preferably in a range of 1:3 to 1:10. When the thickness ratio is within the above-mentioned range, the bonding strength between the layers is improved, and the transparency is also improved.

### <5. Shrinkage Rate>

The heat shrinkage rate in the main shrinkage direction when the heat-shrinkable film 1 is immersed in hot water at 90° C. for 10 seconds and then in water at 20° C. for 10 seconds is preferably 55% or more, and preferably 75% or less. Note that the main shrinkage direction of the heat-shrinkable film 1 is a direction in which the stretch rate of the heat-shrinkable film 1 is the largest. When the heat shrinkage rate is within the above-mentioned range, the heat-shrinkable film 1 can be suitably used for a heat-shrinkable label attached to a resin container without having problems such as poor shrinkage.

### <6. Method for Producing Heat-Shrinkable Film>

### [Formation of Base Material Layer, Printing Layer, etc.]

A method for producing the heat-shrinkable film 1 is not particularly limited. However, an extrusion molding method is preferable. When the heat-shrinkable film 1 has a multilayer structure, each layer can be molded simultaneously by a coextrusion method. When the coextrusion method uses a T-die, as a lamination method, any of a feed block method, a multi-manifold method, and a combination of these methods can be employed.

For example, in the case of the coextrusion method, the raw materials constituting the above-mentioned printing layer 2 and base material layer 4 are each put into an extruder and extruded through a die to obtain a sheet-like product in which each layer is laminated. It is preferable that this sheet-like product is cooled and solidified while being wound up with a take-up roll and then stretched uniaxially or biaxially to produce the heat-shrinkable film 1. As a stretching method, for example, a roll stretching method, a tenter stretching method, or a combination thereof can be employed. The stretching temperature is changed depending on the softening temperature of the resin constituting the heat-shrinkable film 1, the shrinkage characteristics required for the heat-shrinkable film 1, and the like. However, it is preferably 65° C. or higher, more preferably 70° C. or higher, and preferably 120° C. or lower, more preferably 115° C. or lower. In other words, the stretching temperature is preferably 65° C. to 120° C., more preferably 70° C. to 115° C.

The stretch rate in the main shrinkage direction is changed depending on the resin constituting the heat-shrinkable film 1, the stretching means, the stretching temperature, and the like. However, it is preferably 3 times or more, more preferably 4 times or more, and preferably 7 times or less, more preferably 6 times or less. In other words, the stretch rate is preferably 3 times to 7 times, more preferably 4 times to 6 times.

After the above-mentioned extrusion step, a surface to be the printing surface 20 may be appropriately subjected to a surface modification treatment such as a corona treatment. Performing the surface modification treatment improves the adhesion of the ink to the printing surface 20.

### [Formation of Ink Layer]

The ink layer 3 is formed by performing printing using the biomass ink on the printing surface 20 of the heat-shrinkable film 1 that has been subjected to the above-mentioned stretching step. A printing method is not particularly limited, and methods such as gravure printing, flexographic printing, screen printing, and offset printing can be employed.

### <7. Characteristics>

The heat-shrinkable film 1 in which the oxidation induction time T (min) of the printing layer 2 satisfies 0.15≤T≤12 can prevent printing omissions and an increase in cloudiness (haze) after heat shrinkage when the biomass ink is used for printing. This improves the printing quality using the biomass ink.

### EXAMPLES

Examples of the present disclosure will be described in detail below. However, the present disclosure is not limited to these examples.

### 1. Preparation of Examples and Comparative Examples

Heat-shrinkable films according to Examples 1 to 8 and Comparative examples 1 and 2 were prepared using the following method. The heat-shrinkable films of Examples 1 to 4 and 6 had a three-layer structure as shown in FIG. 3, including the base material layer and the printing layers laminated on both sides of the base material layer. The heat-shrinkable films of Examples 5, 7, and 8 and Comparative examples 1 and 2 had a single-layer structure with only the printing layer.

### [Mixing of Raw Materials]

Components shown in Table 1 were used as the raw materials constituting the base material layer and the printing layer, and these components were mixed with the ratio shown in Table 1 to obtain raw material compositions constituting the base material layers and the printing layers according to Examples 1 to 8 and Comparative examples 1 and 2.

### [Film Formation]

Subsequently, each raw material composition was put into an extruder, coextruded through a T-die, and cooled and solidified while being wound up with a take-up roll to produce an unstretched sheet. Each of the produced unstretched sheets was stretched 6 times in a tenter stretching machine including a preheating zone, a stretching zone, and a heat fixing zone, and then wound up using a winding machine to produce a heat-shrinkable film. After stretching, the heat-shrinkable films according to Examples 1 to 4 and 6 had a printing layer thickness of 1 μm, a base material layer thickness of 25 μm, and a total thickness of 27 μm, and the heat-shrinkable films according to Examples 5, 7, and 8 and Comparative examples 1 and 2 had a total thickness of 27 μm.

### [Oxidation Induction Time Measurement]

As a sample, 5 mg of the printing layer was collected from each of the heat-shrinkable films according to Examples 1 to 8 and Comparative examples 1 and 2, and the sample was subjected to the above-mentioned method to measure the oxidation induction time at a setting temperature of 200° C. and 230° C. For the sample in which the oxidation induction time could be measured at both setting temperature, the shorter time was taken as the oxidation induction time T (min). The measured oxidation induction time is shown in Table 1.

TABLE 1

| | | | Measured | | |
|---|---|---|---|---|---|
| | | | oxidation | | Oxidation |
| | | | induction time | | induction |
| | Base material layer | Printing layer | 200° C. | 230° C. | time T |
| Example 1 | Propylene-ethylene- | COC: ethylene-norbornene | 16.54 | 0.49 | 0.49 |
| | butene random | copolymer resin 60 parts by | | | |
| | terpolymer | mass | | | |
| | | PE: C6 linear low-density | | | |
| | | polyethylene 40 parts by mass | | | |
| Example 2 | Propylene-ethylene | COC: ethylene-norbornene | 2.21 | 0.58 | 0.58 |
| | random copolymer | copolymer resin 50 parts by | | | |
| | | mass | | | |
| | | PE: C6 linear low-density | | | |
| | | polyethylene 50 parts by mass | | | |
| Example 3 | Propylene-ethylene- | COC: ethylene-norbornene | — | 5.14 | 5.14 |
| | butene random | copolymer resin 30 parts by | | | |
| | terpolymer | mass | | | |
| | | PE: C6 linear low-density | | | |
| | | polyethylene 70 parts by mass | | | |
| Example 4 | Propylene-ethylene | COC: ethylene-norbornene | — | 11.54 | 11.54 |
| | random copolymer | copolymer resin | | | |
| Example 5 | | PET: Aromatic polyester | 0.39 | 0.39 | 0.39 |
| | | homopolymer 10 parts by mass | | | |
| | | A-PET: Aromatic polyester | | | |
| | | copolymer 90 parts by mass | | | |
| Example 6 | Styrene-butadiene | A-PET: Aromatic polyester | 0.16 | 0.31 | 0.16 |
| | block copolymer | copolymer | | | |
| Example 7 | — | SBS-1: Styrene-butadiene block | 0.30 | 0.31 | 0.30 |
| | | copolymer 50 parts by mass | | | |
| | | SBS-2: Styrene-butadiene block | | | |
| | | copolymer 50 parts by mass | | | |
| Example 8 | — | SBS-1: Styrene-butadiene block | — | 0.41 | 0.41 |
| | | copolymer 50 parts by mass | | | |
| | | SBS-2: Styrene-butadiene block | | | |
| | | copolymer 50 parts by mass | | | |
| Comparative | — | A-PET: Aromatic polyester | — | 12.50 | 12.50 |
| example 1 | | copolymer | | | |
| Comparative | — | SBS-1: Styrene-butadiene block | 0.14 | 0.10 | 0.10 |
| example 2 | | copolymer | | | |

Details of PET, A-PET, SBS-1, and SBS-2 shown in Table 1 are as follows.
(1) PET Aromatic polyester monopolymer including a dicarboxylic acid component (100 mol % of terephthalic acid-derived component), and a diol component (100 mol % of ethylene glycol-derived component)
(2) A-PET Aromatic polyester copolymer including a dicarboxylic acid component (100 mol % of terephthalic acid-derived component), and a diol component (65 mol % of ethylene glycol-derived component, 20 mol % of diethylene glycol-derived component, and 15% of 1,4-cyclohexanedimethanol-derived component), with glass transition temperature of 69° C.
(3) SBS-1 76% by mass of styrene component and 24% by mass of butadiene component, with Vicat softening temperature of 70° C. and MFR at 200° C. of 8 g/10 min
(4) SBS-2 78% by mass of styrene component and 22% by mass of butadiene component, with Vicat softening temperature of 72° C. and MFR at 200° C. of 7 g/10 min

Note that the heat-shrinkable films according to Examples 1, 5, 7, and 8 were formed as the biomass films including the raw materials derived from the biomass resources. The biomass content of each of these biomass films based on the concentration of C14 measured using an accelerator mass spectrometer (9SDH-2 manufactured by NEC Corp.) according to ISO 16620-2:2015 was 10%.

### [Formation of Ink Layer]

Solid printing was performed on the printing surfaces of Examples 1 to 8 and Comparative examples 1 and 2 described above using the biomass ink, thereby forming the ink layers. The printing conditions are as follows.
(1) Printing machine: Gravure printing machine
(2) Heat-shrinkable film width: 900 mm
(3) Biomass ink: Ink including the biomass urethane-based resin as a binder, with printing color of clear and white

Note that there are two types of biomass ink with a biomass content of 15% and 30%. For Examples 1 to 4 and 6 and Comparative examples 1 and 2, the biomass ink with a biomass content of 15% was used, and for Examples 5, 7, and 8, the biomass ink with a biomass content of 30% was used.
(4) Ink viscosity: Zahn cup method, 15 seconds (25° C.) using #3 Zahn cup method
(5) Printing speed: 150 m/min

### <2. Evaluation>

### [Shrinkage Rate]

The heat-shrinkable film after printing was cut into a size of 100 mm in the main shrinkage direction×100 mm in the direction perpendicular to the main shrinkage direction (secondary shrinkage direction) to produce a sample. The number of samples N was 5 for each heat-shrinkable film. Each sample was immersed in hot water at 90° C. for 10 seconds, taken out, and immediately immersed in water at 20° C. for 10 seconds. A length (L1) of one side of the sample in the main shrinkage direction after shrinkage was measured, and the heat shrinkage rate in the main shrinkage direction was determined according to the following formula (1). Similarly, for the secondary shrinkage direction, a length (L2) of one side in the secondary shrinkage direction was measured, and the heat shrinkage rate in the secondary shrinkage direction was measured by replacing LI with L2 in the following formula (1).

$$Heat shrinkage rate ( \% ) = \{ ( 100 - L 1 ) / 100 \} \times 100 \qquad ( 1 )$$

This was repeated for the number of samples N=5 to determine the average value.

### [White Ink Printing Omissions]

A solid white printed part of each heat-shrinkable film was cut into the same size to produce a sample. Each sample was immersed in hot water at 90° C. for 10 seconds, taken out, and immediately immersed in water at 20° C. for 10 seconds for causing shrinkage. Subsequently, each sample was observed with a microscope (VHX-100 manufactured by Keyence Corp.), and the number and size of ink omission parts at 20 randomly selected locations were comprehensively evaluated using the following criteria.
A; Almost no ink omission parts as a whole (less than 1% of the whole)
B; A few ink omission parts as a whole (1 to 3% of the whole)
C; Relatively large number of ink omission parts as a whole (over 3% of the whole)

### [Haze After Printing Before Shrinkage]

After printing, each heat-shrinkable film before heat-shrinkage was cut to the same size to produce a sample. For each sample, the haze (%) of the printed part using clear ink was measured. The measurement was performed using a haze meter (NDH5000 manufactured by Nippon Denshoku Industries Co., Ltd.) using a method according to the standard of JIS K 7136.

### [Haze After Printing and Shrinkage]

Each sample subjected to the haze measurement after printing before shrinkage was immersed in hot water at 98° C. for 30 seconds and then taken out so that the sample was uniformly shrunk by 30% in the main shrinkage direction. Subsequently, the haze (%) of the printed part using the clear ink was measured in the same manner as before shrinkage, and the haze value was evaluated as follows.
A; Haze of less than 5 (good appearance)
B; Haze of less than 7 (acceptable range)
C; Haze of 7 or more (poor appearance)

### <3. Evaluation Results>

The evaluation results were as shown in Table 2 below.

TABLE 2

| | Biomass | Shrinkage rate | | Clear ink | Clear ink |
|---|---|---|---|---|---|
| | ink | (secondary shrinkage | White ink | printing haze | printing |
| | biomass | direction/main | printing | before | haze after |
| | content | shrinkage direction) | omissions | shrinkage | shrinkage |
| Example 1 | 15% | 2/72 | A | 3.1 | 3.8 (A) |
| Example 2 | 15% | 6/63 | A | 4.3 | 4.8 (A) |
| Example 3 | 15% | −1/70 | A | 3.2 | 5.9 (B) |
| Example 4 | 15% | 0/67 | A | 2.7 | 5.5 (B) |
| Example 5 | 30% | −1/68 | A | 3.4 | 4 (A) |
| Example 6 | 15% | 1/70 | B | 3.5 | 4.1 (A) |
| Example 7 | 30% | 0/67 | A | 3.3 | 3.9 (A) |
| Example 8 | 30% | 1/68 | A | 3.4 | 4 (A) |
| Comparative | 15% | 3/76 | A | 3.5 | 7.8 (C) |
| example 1 | | | | | |
| Comparative | 15% | 5/77 | C | 3.5 | 5.1 (B) |
| example 2 | | | | | |

As shown in Table 2, in Examples 1 to 8, the shrinkage rates in the main shrinkage direction were all within the acceptable range. However, in Comparative examples 1 and 2, the shrinkage rates in the main shrinkage direction exceeded the upper limit of the preferable range. Further, in Examples 1 to 8, printing defects hardly occurred even when the biomass ink was used. On the other hand, Comparative example 1 with the long oxidation induction time had the increased haze after shrinkage and was evaluated as poor appearance. Further, in Comparative example 2 with the short oxidation induction time, the degree of white ink printing omissions was increased. Among Examples, Example 6 with the short oxidation induction time had a relatively large number of white ink printing omissions compared to other Examples, although the number was still within the acceptable range. Thus, it is speculated that the shorter oxidation induction time has the greater influence on the printing omissions. Further, in Examples 1, 2, 5, 7, and 8, both the printing omissions and the haze after shrinkage were prevented, and the appearance was relatively good. In particular, in Examples 5, 7, and 8 using the biomass ink with a relatively high biomass content, both the printing omissions and the haze after shrinkage were favorably prevented.

### LIST OF REFERENCE NUMERALS

1 Heat-shrinkable film
2 Printing layer
3 Ink layer
4 Base material layer
20 Printing surface

1. A heat-shrinkable film for lamination of an ink layer formed by biomass ink, comprising:
a printing layer comprising a thermoplastic resin and having a printing surface configured to allow the ink layer to be laminated,
wherein an oxidation induction time T (min) of the printing layer satisfies 0.15≤T≤12; and
the oxidation induction time T is an oxidation induction time T1 measurable in air at 200° C., an oxidation induction time T2 measurable in the air at 230° C., or a shorter one of the T1 and the T2.

2. The heat-shrinkable film according to claim 1, wherein the printing layer mainly includes any of an olefin-based resin, an ester-based resin, and a styrene-based resin.

3. The heat-shrinkable film according to claim 1, further comprising a base material layer including a thermoplastic resin and laminated on a surface of the printing layer opposite to the printing surface.

4. The heat-shrinkable film according to claim 1, wherein the oxidation induction time T (min) satisfies 0.2≤T≤5.

5. The heat-shrinkable film according to claim 1, wherein the biomass ink includes a urethane-based resin, and the urethane-based resin includes a component derived from a biomass resource.

6. The heat-shrinkable film according to claim 1, wherein the biomass ink has a biomass content of 10% or more.

7. The heat-shrinkable film according to claim 1, wherein the ink layer is laminated on the printing surface.

8. A heat-shrinkable label comprising the heat-shrinkable film according to claim 7.

9. The heat-shrinkable film according to claim 2, further comprising a base material layer including a thermoplastic resin and laminated on a surface of the printing layer opposite to the printing surface.

10. The heat-shrinkable film according to claim 2, wherein the oxidation induction time T (min) satisfies 0.2≤T≤5.

11. The heat-shrinkable film according to claim 2, wherein the biomass ink includes a urethane-based resin, and the urethane-based resin includes a component derived from a biomass resource.

12. The heat-shrinkable film according to claim 2, wherein the biomass ink has a biomass content of 10% or more.

13. The heat-shrinkable film according to claim 2, wherein the ink layer is laminated on the printing surface.

14. The heat-shrinkable film according to claim 3, wherein the oxidation induction time T (min) satisfies 0.2≤T≤5.

15. The heat-shrinkable film according to claim 3, wherein the biomass ink includes a urethane-based resin, and the urethane-based resin includes a component derived from a biomass resource.

16. The heat-shrinkable film according to claim 3, wherein the biomass ink has a biomass content of 10% or more.

17. The heat-shrinkable film according to claim 3, wherein the ink layer is laminated on the printing surface.

18. The heat-shrinkable film according to claim 4, wherein the biomass ink includes a urethane-based resin, and the urethane-based resin includes a component derived from a biomass resource.

19. The heat-shrinkable film according to claim 4, wherein the biomass ink has a biomass content of 10% or more.

20. The heat-shrinkable film according to claim 4, wherein the ink layer is laminated on the printing surface.
